(19) United States
(12) Patent Application Publication
(10) Pub. No.: US 2022/0388890 A1
(43) Pub. Date: Dec. 8, 2022

(54) METHOD OF CUTTING COMBINED STRUCTURE OF GLASS SUBSTRATE AND LIGHT-ABSORBING PLATE

(71) Applicant: CORNING INCORPORATED, CORNING, NY (US)

(72) Inventors: Joo Sok Kim, Yongin-si (KR); Cheol Hee Park, Asan-si (KR); Dong Keun Shin, Hwasung-si (KR)

(21) Appl. No.: 17/777,419

(22) PCT Filed: Nov. 19, 2020
(86) PCT No.: PCT/US2020/061153

§ 371 Date: May 17, 2022

(30) Foreign Application Priority Data
Nov. 20, 2019 (KR) 10-2019-0149878

(51) Int. Cl. C03B 33/08; C03B 33/02; C03B 33/07; C03B 33/10

(52) U.S. Cl. CPC C03B 33/082; C03B 33/0222; C03B 33/074; C03B 33/102

(57) ABSTRACT

A method of cutting a combined structure of a glass substrate and a light absorbing plate includes providing a glass substrate on a metal plate, providing a light absorbing material at an edge of the glass substrate, and cutting the glass substrate and the light absorbing plate by irradiating a laser beam to the glass substrate from the edge to which the light absorbing material is provided.

### CROSS-REFERENCE TO RELATED APPLICATION

This application claims the benefit of Korean Patent Application No. 10-2019-0149878, filed on Nov. 20, 2019, in the Korean Intellectual Property Office, the disclosure of which is incorporated herein in its entirety by reference.

### BACKGROUND

### 1. Field

The disclosure relates to a method of cutting a combined structure of a glass substrate and a light-absorbing plate, and more particularly, to a method of cutting, with improved reliability, a combined structure of a glass substrate and a light-absorbing plate.

### 2. Description of Related Art

In general, a method of cutting a combined structure of a glass substrate and a light-absorbing plate may be a mechanical cutting method, a chemical cutting method, and a cutting method using laser.

A mechanical cutting method for a glass substrate uses a cutting tool such as a diamond wheel or a sand blaster. The cutting tool may have strength greater than that of a glass substrate that is to be processed. After a scribe line is formed on a surface of a glass substrate by moving a cutting tool in contact with the glass substrate along a cutting path, the cutting tool is pressed against the glass substrate along the scribe line, thereby cutting the combined structure of the glass substrate and a light-absorbing plate.

However, tempered glass having high hardness may be weak against such mechanical impact, and cracks may be generated in undesirable directions. Furthermore, it is quite difficult to handle glass dust scattering during a cutting process, and also, costs are high due to wear of a diamond wheel.

A typical chemical cutting method for a glass substrate is an etching method. A chemical cutting method causes an environment contamination problem due to use of chemicals and deteriorates productivity due to a relatively extended processing time.

A glass substrate cutting method using laser is advantageous in view of the quality of a cutting surface and a processing speed, but problematic in that the rate of occurrence of cracks in the glass substrate during cutting is rather high. Accordingly, in order to improve manufacturing yield, various methods for preventing cracks during glass cutting have been studied.

### SUMMARY

Provided is a method of cutting, with improved reliability, a combined structure of a glass substrate and a light-absorbing plate.

Additional aspects will be set forth in part in the description which follows and, in part, will be apparent from the description, or may be learned by practice of the presented embodiments of the disclosure.

According to an embodiment of the disclosure, a method of cutting a combined structure of a glass substrate and a light absorbing plate includes providing a glass substrate on a metal plate, providing a light absorbing material at an edge of the glass substrate, and cutting the glass substrate and the light absorbing plate by irradiating a laser beam to the glass substrate from the edge to which the light absorbing material is provided.

In some embodiments, the laser beam may be generated by an optical fiber laser.

In some embodiments, the providing of the light absorbing material may include providing the light absorbing material with a greater width than a width of the laser beam.

In some embodiments, the light absorbing material may include a color ink.

In some embodiments, the method may further include removing the light absorbing material after the cutting of the glass substrate and the light absorbing plate.

In some embodiments, the providing of the light absorbing material may include providing the light absorbing material to a surface of the glass substrate.

In some embodiments, the providing of the light absorbing material may include providing the light absorbing material to an upper surface of the glass substrate.

In some embodiments, the providing of the light absorbing material may include providing the light absorbing material to a side surface of the glass substrate.

In some embodiments, the providing of the light absorbing material may include providing the light absorbing material simultaneously to the glass substrate and the metal plate.

In some embodiments, the providing of the light absorbing material may include providing the light absorbing material to an upper surface and a side surface of the glass substrate.

In some embodiments, the light absorbing material may extend along the edge.

In some embodiments, the cutting of the glass substrate and the light absorbing plate may include irradiating the laser beam in a direction perpendicular to the edge.

According to an embodiment of the disclosure, a method of cutting a combined structure of a glass substrate and a light absorbing plate includes disposing a glass substrate on a light absorbing plate, providing, on the glass substrate, a light absorbing material extending in one direction, and cutting the glass substrate and the light absorbing plate by irradiating a laser beam to the glass substrate moving in a direction perpendicular to one direction.

In some embodiments, the light absorbing material may be provided to a portion of an edge of the glass substrate.

In some embodiments, the method may further include removing the light absorbing material after the cutting of the glass substrate and the light absorbing plate.

In some embodiments, the laser beam may pass through the glass substrate and reaches the light absorbing plate.

In some embodiments, a width of the laser beam may be less than a length of the light absorbing material in the one direction.

According to an embodiment of the disclosure, a method of cutting a combined structure of a glass substrate and a light absorbing plate, the method including providing a glass substrate on a light absorbing plate, providing a light absorbing material at a boundary between the glass substrate and the light absorbing plate, and cutting the glass substrate and the light absorbing plate by irradiating a laser beam to the light absorbing plate and the glass substrate to pass over the light absorbing material.

In some embodiments, the light absorbing material may extend from an edge of the glass substrate.

In some embodiments, the method may further include removing the light absorbing material after the cutting of the glass substrate and the light absorbing plate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart of a method of cutting a combined structure of a glass substrate and a light-absorbing plate, according to an embodiment.

FIG. 2 is a plan view for describing a method of cutting a combined structure of a glass substrate and a light-absorbing plate, according to an embodiment.

FIG. 3A is a plan view for describing a method of cutting a combined structure of a glass substrate and a light-absorbing plate, according to an embodiment.

FIG. 3B is a cross-sectional view taken along line 3A-3A′ of FIG. 3A.

FIG. 3C is a cross-sectional view corresponding to FIG. 3B.

FIG. 4A is a plan view for describing a light absorbing material according to other embodiment light absorbing material.

FIGS. 4B and 4C are cross-sectional views taken along line 4A-4A′ of FIG. 4A.

FIGS. 5A and 5B are cross-sectional views of light absorbing materials according to other embodiments.

FIG. 6A is a plan view for describing a method of cutting a combined structure of a glass substrate and a light-absorbing plate, according to another embodiment.

FIG. 6B is a cross-sectional view taken along line 6A-6A′ of FIG. 3A.

FIG. 7A is an image showing a result of cutting a glass substrate according to an experimental example.

FIG. 7B is an image showing a result of cutting a glass substrate according to a comparative example.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

While such terms as “first,” “second,” etc., may be used to describe various components, such components must not be limited to the above terms. The above terms are used only to distinguish one component from another. For example, without departing from the right scope of the disclosure, a first constituent element may be referred to as a second constituent element, and vice versa.

Terms used in the specification are used for explaining a specific embodiment, not for limiting the disclosure. The expression of singularity in the specification includes the expression of plurality unless clearly specified otherwise in context. Also, terms such as “comprise” and/or “comprising” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. Furthermore, the terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

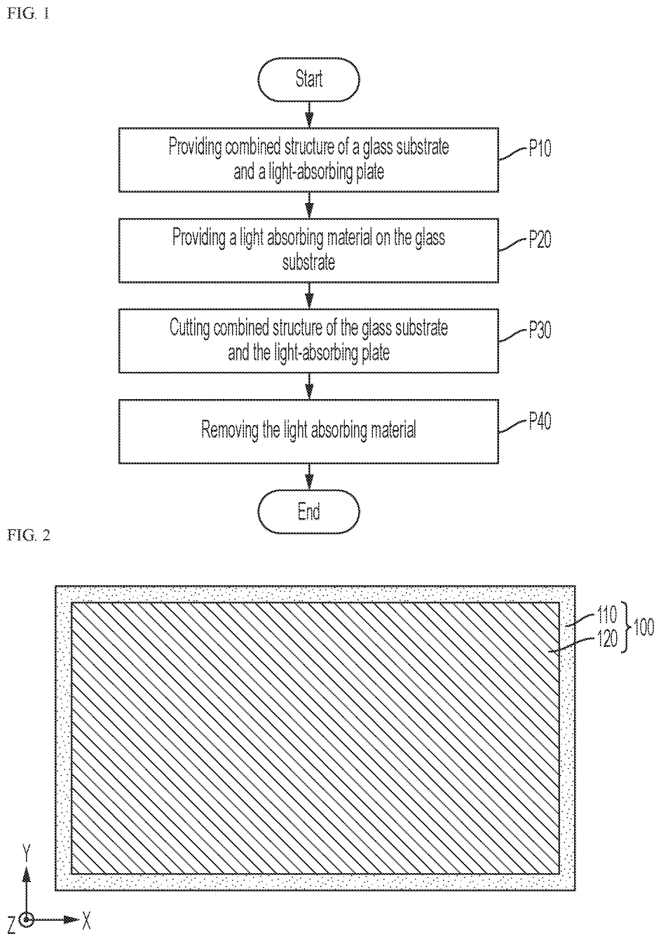

FIG. 1 is a flowchart of a method of cutting a combined structure 100 of a glass substrate 120 and a light-absorbing plate 110, according to an embodiment.

FIG. 2 is a plan view for describing a method of cutting the combined structure 100 of the glass substrate 120 and the light-absorbing plate 110, according to an embodiment.

Referring to FIGS. 1 and 2, in operation P10, the combined structure 100 of the glass substrate 120 and the light-absorbing plate 110 may be provided.

According to some embodiments, the glass substrate 120 may be fixed to the light-absorbing plate 110. However, the disclosure is not limited thereto, and the glass substrate 120 may be simply disposed on the light-absorbing plate 110 without any special fixing process or fixing device.

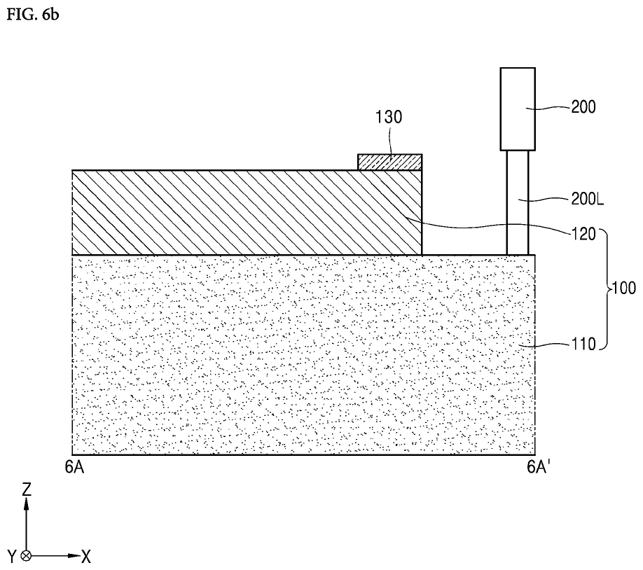

The light-absorbing plate 110 may include a light-absorbing material. According to some embodiments, the light-absorbing plate 110 may include a metal. According to some embodiments, the light-absorbing plate 110 may include a metal, such as Al, Cu, Ag, Zn, or Fe, but the disclosure is not limited thereto. The light-absorbing plate 110 may include a material having a high absorption rate and a high thermal conductivity with respect to a laser beam 200L (see FIG. 6B) that is described later.

Although FIG. 2 illustrates that the light-absorbing plate 110 has a rectangular flat panel shape, the disclosure is not limited thereto. The light-absorbing plate 110 may have various shapes and sizes according to the shape and size of the glass substrate 120 disposed on the light-absorbing plate 110.

According to some embodiments, the glass substrate 120 may include tempered glass. The tempered glass may be tempered by using a strengthening solution such as potassium nitrate (KNO₃). In general, tempered glass exhibits excellent strength characteristics compared to a typical glass substrate during a change of pressure and temperature, and when broken, the tempered glass breaks into small grains so as to reduce a risk of debris. Due to the above excellent characteristics, the tempered glass has been widely used for solar cells, display devices, vehicles, or buildings. However, the disclosure is not limited thereto, and according to some embodiments, the glass substrate 120 may include non-tempered glass.

The two directions that are parallel to an upper surface of the glass substrate 120 and substantially perpendicular to each other are defined as first and second directions (X direction and Y direction). Furthermore, a direction perpendicular to the upper surface of the glass substrate 120 is defined as a third direction (Z direction). The definitions of the above-described directions are identical in all drawings below unless otherwise mentioned.

The glass substrate 120 may have an approximately rectangular flat panel shape. A pair of edges of the glass substrate 120 may be parallel to the first direction (X direction), and another pair of edges thereof may be parallel to the second direction (Y direction).

The glass substrate 120 may have a thickness to allow a laser beam that has transmitted through the glass substrate 120, to be sufficiently transmitted to the light-absorbing plate 110. According to some embodiments, the glass substrate 120 may have a thickness of about 1.0 mm to about 0.1 mm, but the disclosure is not limited thereto.

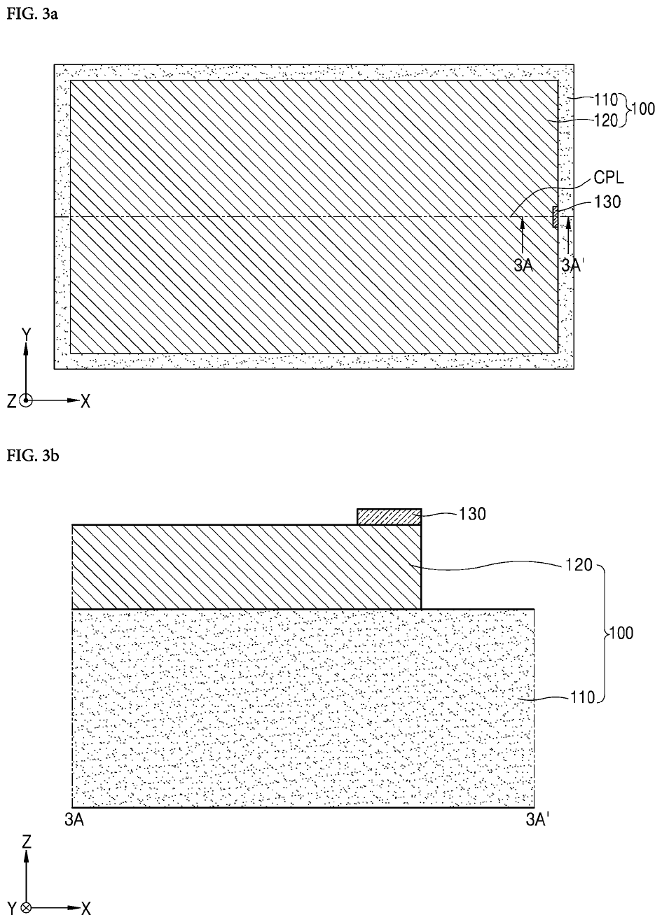

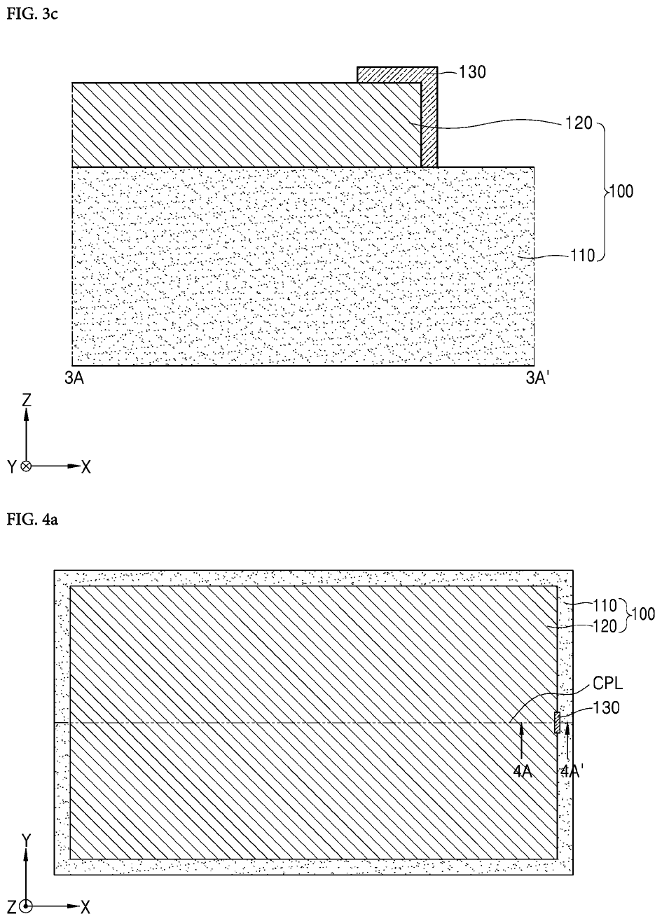

FIG. 3A is a plan view for describing a method of cutting the combined structure 100 of the glass substrate 120 and the light-absorbing plate 110, according to an embodiment. FIG. 3B is a cross-sectional view taken along line 3A-3A′ of FIG. 3A.

Referring to FIGS. 1, 3A, and 3B, in operation P20, a light absorbing material 130 may be provided on the glass substrate 120.

According to some embodiments, the light absorbing material 130 may be provided close to an edge of the glass substrate 120. According to some embodiments, the light absorbing material 130 may be provided at a boundary portion between the light-absorbing plate 110 and the glass substrate 120. According to some embodiments, the light absorbing material 130 may be provided on a surface of the glass substrate 120. According to some embodiments, the light absorbing material 130 may extend from the edge of the glass substrate 120 along the edge. According to some embodiments, the light absorbing material 130 may be provided at an end portion of the glass substrate 120 in the first direction (X direction). According to some embodiments, the length of the light absorbing material 130 in the second direction (Y direction) may be greater than the length in the first direction (X direction). According to some embodiments, the light absorbing material 130 may be provided on the upper surface of the glass substrate 120.

According to some embodiments, the length of the light absorbing material 130 in the first direction (X direction) may be less than or equal to several millimeters. According to some embodiments, the length of the light absorbing material 130 in the first direction (X direction) may be several micrometers to several hundreds of micrometers. According to some embodiments, the length of the light absorbing material 130 in the second direction (Y direction) may be several millimeters to several tens of millimeters.

According to some embodiments, the light absorbing material 130 may be provided at an end portion of a cutting line (CPL) that is a virtual line along which cutting of the glass substrate 120 is performed in a subsequent process.

According to some embodiments, the light absorbing material 130 may be formed by fixing an oil-based ink. According to some embodiments, the light absorbing material 130 may be formed by fixing a water-based ink. According to some embodiments, the light absorbing material 130 may be black, but the disclosure is not limited thereto. According to some embodiments, the light absorbing material 130 may include a material having a high absorption rate with respect to a laser beam 200L (see FIG. 6B) that is described later. In other words, the light absorbing material 130 may include a material having a high absorption rate with respect to a wavelength band of a laser beam in use.

Referring to FIG. 3A, although the light absorbing material 130 is illustrated to have an approximately line shape, the disclosure is not limited thereto. The light absorbing material 130 may have various shapes such as a dot shape, a wedge shape, or an irregular shape. Furthermore, in some cases, the light absorbing material 130 may have a line shape extending in the CPL.

FIG. 3C is cross-sectional views taken along line A-A′ of FIG. 3A which illustrate the light absorbing materials 130 provided in different methods from that of FIG. 3B.

Referring to FIG. 3C, the light absorbing material 130 may be provided on the upper and lateral surfaces of the glass substrate 120.

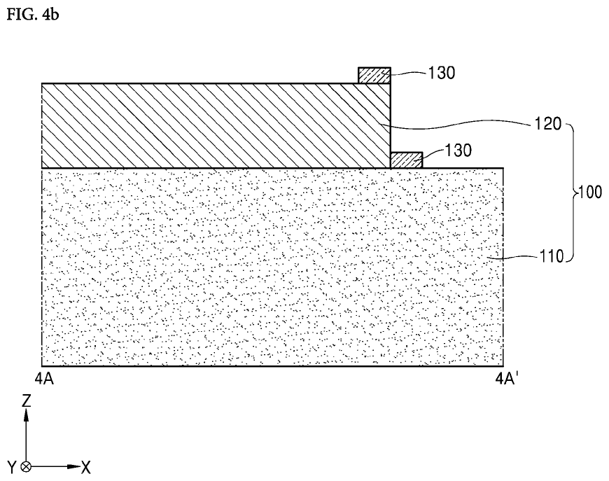

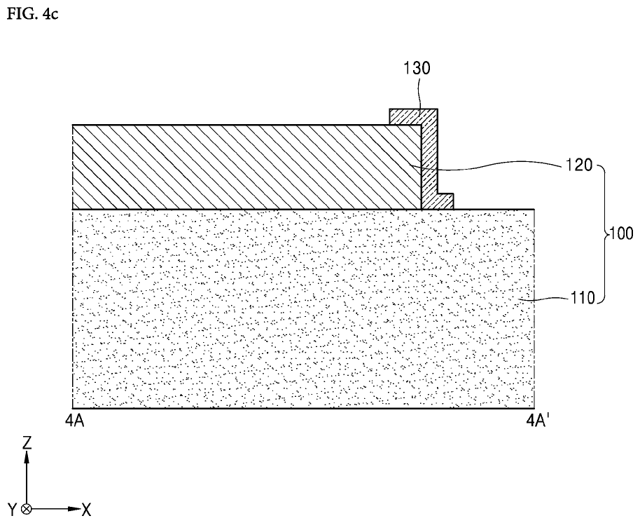

FIG. 4A is a plan view for describing a light absorbing material 130 according to other embodiment. FIGS. 4B and 4C are cross-sectional views taken along line 4A-4A′ of FIG. 4A.

Referring to FIGS. 1, 4A, and 4B, the light absorbing material 130 may be provided on each of the light-absorbing plate 110 and the glass substrate 120.

According to some embodiments, the light absorbing material 130 may be provided on the upper surface of each of the light-absorbing plate 110 and the glass substrate 120. According to some embodiments, the light absorbing material 130 may be provided only on the upper surface of each of the light-absorbing plate 110 and the glass substrate 120. According to some embodiments, the light absorbing material 130 may not be provided on at least a portion of the lateral surface of the glass substrate 120.

However, the disclosure is not limited thereto, and referring to FIG. 4C, the light absorbing material 130 may be provided on the upper surface of the light-absorbing plate 110 and the upper and lateral surfaces of the glass substrate 120.

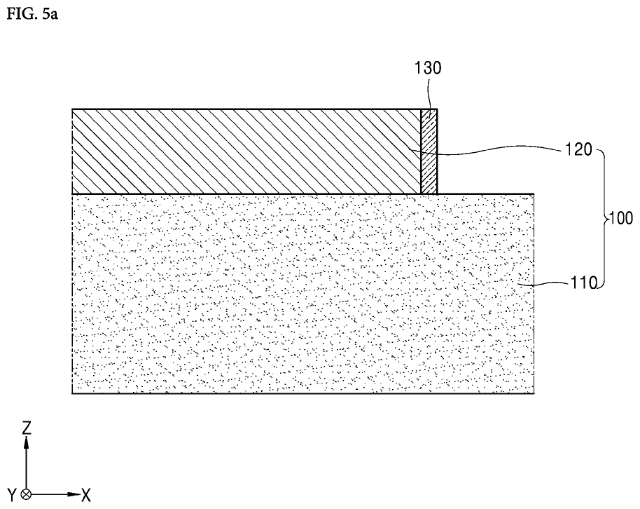

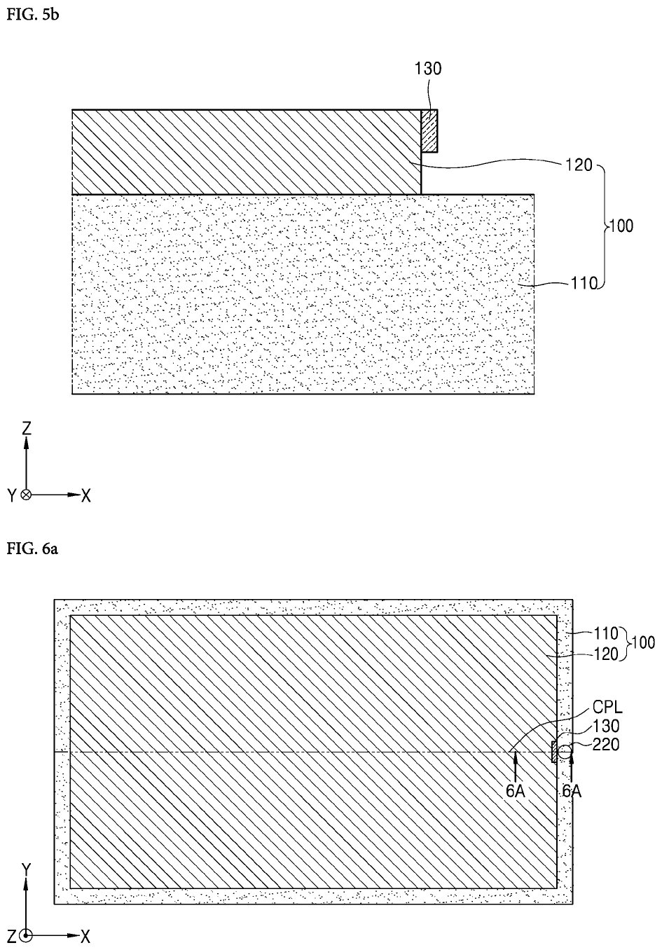

FIG. 5A AND 5B are cross-sectional views of the light absorbing materials 130 according to other embodiments, and more specifically, correspond to the same portion in FIG. 3B.

Referring to FIG. 5A, the light absorbing material 130 may be provided on the lateral surface of the glass substrate 120. According to some embodiments, the light absorbing material 130 may be provided on at least the lateral surface of the glass substrate 120 that intersects the CPL of FIG. 3A. According to some embodiments, the light absorbing material 130 may be provided only on the lateral surface of the glass substrate 120. According to some embodiments, the length of the light absorbing material 130 in the third direction (Z direction) may be substantially equal to the thickness of the glass substrate 120.

Referring to FIG. 5B, the light absorbing material 130 may be provided on the lateral surface of the glass substrate 120. According to some embodiments, the length of the light absorbing material 130 in the third direction (Z direction) may be less than the thickness of the glass substrate 120. According to some embodiments, the light absorbing material 130 may be provided only on an upper portion of the lateral surface of the glass substrate 120.

FIG. 6A is a plan view for describing a method of cutting the combined structure 100 of the glass substrate 120 and the light-absorbing plate 110, according to another embodiment. FIG. 6B is a cross-sectional view taken along line 6A-6A′ of FIG. 3A.

Referring to FIGS. 1, 6A, and 6B, in operation P30, the combined structure 100 of the glass substrate 120 and the light-absorbing plate 110 may be cut.

According to some embodiments, the cutting of the combined structure 100 of the glass substrate 120 and the light-absorbing plate 110 may include irradiating cutting a laser beam 200L of a laser 200 along the CPL.

According to some embodiments, the laser 200 may include a gas laser such as a Ne—He laser, an Ar laser, or a CO₂ laser. According to some embodiments, the laser 200 may include a solid laser such as an Al₂O₃ laser. According to some embodiments, the laser 200 may include a fiber laser. The fiber laser is a laser using an optical fiber as a resonator. According to some embodiments, the fiber laser may be implemented by, for example, an optical fiber doped with neodymium ions (Nd³⁺). According to some embodiments, the fiber laser may oscillate continuously, or as pulses, a laser beam having a wavelength of about 1.06 μm, but the disclosure is not limited thereto. According to some embodiments, the laser 200 may include a semiconductor laser such as an AlGaAs laser or an InGaAs laser. According to some embodiments, the laser 200 may be a liquid laser or a KrF excimer laser, but the disclosure is not limited thereto.

According to some embodiments, the laser beam 200L may have a high transmissivity with respect to the glass substrate 120. According to some embodiments, the laser beam 200L may not be substantially absorbed by the glass substrate 120. According to some embodiments, the laser beam 200L may be absorbed by the light-absorbing plate 110. According to some embodiments, as the laser beam 200L is absorbed, the temperature of the light-absorbing plate 110 to which the laser beam 200L is irradiated may be increased. Accordingly, the glass substrate 120 on a portion of the light-absorbing plate 110 where the temperature is increased may be melted and cut.

According to some embodiments, the laser beam 200L may be irradiated in the third direction (Z direction). According to some embodiments, the laser beam 200L may travel in the first direction (X direction). According to some embodiments, when the light absorbing material 130 is provided with a line shape, the laser beam 200L may be irradiated in a direction, for example, in the first direction (X direction), that is substantially perpendicular to an extension direction of the light absorbing material 130, for example, in the second direction (Y direction). According to some embodiments, the width of a beam of the laser beam 200L may be less than the length of the light absorbing material 130 in the second direction (Y direction).

According to some embodiments, a cooling gas may be provided with the irradiation of the laser beam 200L. According to some embodiments, the cooling gas may include N₂, Ar, or Air, but the disclosure is not limited thereto. The cooling gas is provided to cool a cutting surface of the glass substrate 120 and remove impurities.

According to some embodiments, the light absorbing material 130 may be provided at a location where the irradiation of the laser beam 200L to the glass substrate 120 starts. As the laser beam 200L that has irradiated only the light-absorbing plate 110 is able to irradiate the light-absorbing plate 110 by transmitting through the glass substrate 120, a portion of the laser beam 200L may arrive at the light-absorbing plate 110 in an unintended direction, for example, a direction that is different from the traveling direction of the laser beam 200L, and thus cracks may be generated in the glass substrate 120. In the glass cutting according to the related art, cracks may be generated with a high frequency within a region about 5 mm apart from a point where the glass cutting is mainly started, that is, a point where the laser beam 200L is first irradiated to glass. When the length of a crack is less than about 300 μm, the crack may be removed by grinding the cutting surface. When the length of a crack is greater than or equal to about 300 μm, the crack may not be removed by a grinding process and may cause a critical defect in the quality of a final product. The length of a crack denotes the length of a crack extending in a direction parallel to the upper surface of the glass substrate 120.

According to some embodiments, the light absorbing material 130 prevents scattering of the laser beam 200L that starts to be incident on the glass substrate 120, thereby preventing the generation of cracks.

This description regarding the nature of a scientific principle is provided to understand the technical concept of the disclosure and does not limit the disclosure in any sense. The scope of rights according to the technical concept of the disclosure is determined by the accompanying claims and the equivalent general analysis and is not limited by the above-described principle.

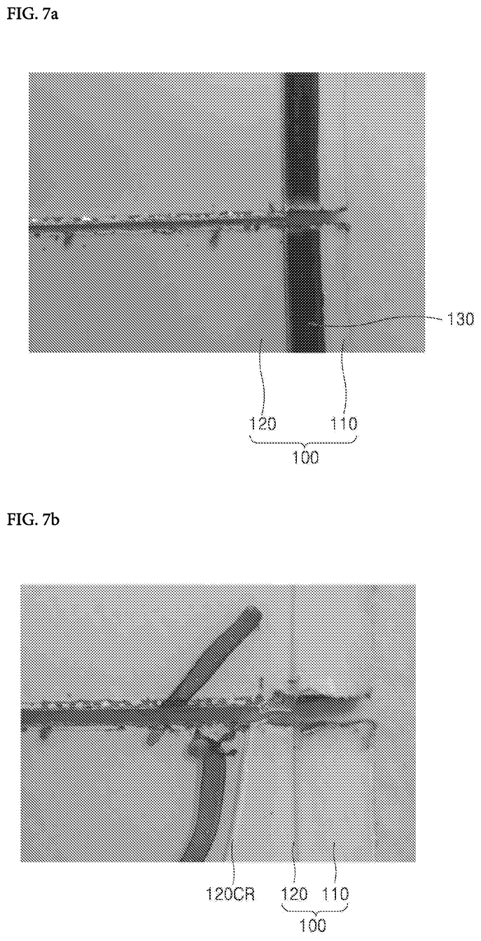

FIG. 7A is an image showing a result of cutting a glass substrate 120 according to an experimental example. FIG. 7B is an image showing a result of cutting the glass substrate 120 according to a comparative example.

According to the experimental example and the comparative example of FIGS. 7A and 7B, the glass substrates 120 each are cut by a fiber laser. As a fiber laser having an output of about 5 kW travels on the glass substrate 120 at a speed of about 1.5 m/s to about 2 m/s, the combined structure 100 of the glass substrate 120 and the light-absorbing plate 110 is cut. During cutting by using a laser, a N₂ gas at a pressure of about 10 psi is applied onto the cutting surface. A distance between a nozzle of the fiber laser, that is, an exit surface of a laser beam, and the glass substrate 120, and a focal distance of the fiber laser, are each about 2 mm.

Referring to FIG. 7A, after the light absorbing material 130 is provided on the light-absorbing plate 110 and the glass substrate 120, the combined structure 100 of the glass substrate 120 and the light-absorbing plate 110 is cut. The light absorbing material 130 may include a black oil-based ink. No crack is generated in the glass substrate 120 that is cut after the light absorbing material 130 is provided.

Referring to FIG. 7B, the combined structure 100 of the glass substrate 120 and the light-absorbing plate 110 is cut without providing the light absorbing material 130. It may be checked that a crack 120CR is generated in the glass substrate 120 that is cut.

Table 1 shows an effect of a method of cutting the combined structure 100 of the glass substrate 120 and the light-absorbing plate 110, according to an embodiment. Referring to Table 1, when the combined structure 100 of the glass substrate 120 and the light-absorbing plate 110 is cut after the light absorbing material 130 is provided, it may be seen that a crack rate is remarkably lowered.

TABLE 1

| | Light absorbing | Light absorbing |
|---|---|---|
| | material not | material |
| | provided | provided |
| No. of cut glass | 76 | 56 |
| substrates | | |
| No. of cracks | 45 | 2 |
| Crack rate | 59.2% | 3.6% |

According to the disclosure, when a glass substrate is cut, the generation of a crack may be effectively restricted. Accordingly, as a manufacturing yield increases, reliability of the manufactured glass substrate may be enhanced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A method of cutting a combined structure of a glass substrate and a light absorbing plate, the method comprising:
providing a glass substrate on a metal plate;
providing a light absorbing material at a portion of an edge of the glass substrate; and
cutting the glass substrate and the light absorbing plate by irradiating a laser beam to the glass substrate from the edge to which the light absorbing material is provided.

2. The method of claim 1, wherein the laser beam is generated by an optical fiber laser.

3. The method of claim 1, wherein the providing of the light absorbing material comprises providing the light absorbing material with a greater width than a width of the laser beam.

4. The method of claim 1, wherein the light absorbing material comprises a color ink.

5. The method of claim 1, further comprising removing the light absorbing material after the cutting of the glass substrate and the light absorbing plate.

6. The method of claim 1, wherein the providing of the light absorbing material comprises providing the light absorbing material to a surface of the glass substrate.

7. The method of claim 1, wherein the providing of the light absorbing material comprises providing the light absorbing material to an upper surface of the glass substrate.

8. The method of claim 1, wherein the providing of the light absorbing material comprises providing the light absorbing material to a side surface of the glass substrate.

9. The method of claim 1, wherein the providing of the light absorbing material comprises providing the light absorbing material simultaneously to the glass substrate and the metal plate.

10. The method of claim 9, wherein the providing of the light absorbing material comprises providing the light absorbing material to an upper surface and a side surface of the glass substrate.

11. The method of claim 1, wherein the light absorbing material extends along the edge.

12. The method of claim 1, wherein the cutting of the glass substrate and the light absorbing plate comprises irradiating the laser beam in a direction perpendicular to the edge.

13. A method of cutting a combined structure of a glass substrate and a light absorbing plate, the method comprising:
disposing a glass substrate on a light absorbing plate;
providing, on the glass substrate, a light absorbing material extending in one direction; and
cutting the glass substrate and the light absorbing plate by irradiating a laser beam to the glass substrate moving in a direction perpendicular to one direction.

14. The method of claim 13, wherein the light absorbing material is provided to a portion of an edge of the glass substrate.

15. The method of claim 13, further comprising removing the light absorbing material after the cutting of the glass substrate and the light absorbing plate.

16. The method of claim 13, wherein the laser beam passes through the glass substrate and reaches the light absorbing plate.

17. The method of claim 13, wherein a width of the laser beam is less than a length of the light absorbing material in the one direction.

18. A method of cutting a combined structure of a glass substrate and a light absorbing plate, the method comprising:
providing a glass substrate on a light absorbing plate;
providing a light absorbing material at a boundary between the glass substrate and the light absorbing plate; and
cutting the glass substrate and the light absorbing plate by irradiating a laser beam to the light absorbing plate and the glass substrate to pass over the light absorbing material.

19. The method of claim 18, wherein the light absorbing material extends from an edge of the glass substrate.

20. The method of claim 18, further comprising removing the light absorbing material after the cutting of the glass substrate and the light absorbing plate.
